(19) United States
(12) Patent Application Publication
(10) Pub. No.: US 2005/0044781 A1
(43) Pub. Date: Mar. 3, 2005

(54) Ecological brick for slope lands

(76) Inventors: Shih-Chieh Chen, Taoyuan City (TW); Chi-Yi Liou, San Chong City (TW); Teng-Yu Chen, Ba-TE City (TW)

Correspondence Address: BIRCH STEWART KOLASCH & BIRCH, PO BOX 747, FALLS CHURCH, VA, 22040-0747, US

(21) Appl. No.: 10/646,750

(22) Filed: Aug. 25, 2003

(51) Int. Cl. E02B 3/12; A01G 9/02

(52) U.S. Cl. 47/1.01 T; 405/16

(57) ABSTRACT

An ecological brick for slope lands is made from virgin materials or wasted materials and formed in a porous structure to equip water permeable and retaining properties. The brick has one side forming a space for growing plants. The space has a portion forming a cavity located deeply in the interior of the brick for holding the plants. The brick has means to couple with one another such as through holes to receive elongated reinforced bars or insert pins. The coupling means may also be formed on the peripheral sides of the brick to allow the brick to wedge and couple with one another.

### BACKGROUND OF THE INVENTION

1. Field of the Invention

The invention relates to an ecological brick for slope lands and particularly to a brick that has water retaining and permeable properties and has space for growing plants and interconnecting means to serve as construction material for slope lands.

2. Description of the Prior Art

Some land development projects such as building roads or construction engineering usually involve slope land development. Plants do not cover the excavated slope land and crumbling often occurs. Hence land protection engineering is very important after the slope land is formed. The most commonly approach to mend the slope land at present is to build a manmade sloping bank. It is generally a small slope and stepwise construction with a trapezoid gradient to avoid the slope land from sliding caused by the steep land surface after construction. Moreover, the slope land usually is covered by cement grouting or a Ferro-concrete protection wall. These protection measures have disadvantages, notably the land surface cannot grow plants. Hence the slope land cannot be restored to its original landscape. In addition, the cement slope land has to reserve water vents to allow water in the soil to seep out and discharge. During heavy rain, water accumulates in the soil rapidly and often cannot be drained effectively. It often happens that the slope land cannot withstand the huge inner pressure and results in collapse or landslide. There is other type of slope land protection approach that adopts serpentine cages or stacking rocks. While this approach enables the slope land to partly restore to its original condition, and its surface has more irregular drain gutters to infiltrate water from the soil at the earlier stage and reduce the pressure that might otherwise cause crumbling, it also has the disadvantage existed in the cement wall, i.e. difficult to grow plants. Although the rocks or serpentine cages have some cracks to allow weeds to grow, it is difficult to cultivate desired plants on desired locations. The contemporary methods of systematic cultivating plants on the slope land mostly are to cover the slope land with meshes and grow the plants thereon. However, such type of planting merely is limited to crawling plants such as vines.

Thus the prior approach of cementing the slope land is against the water drain principle of the natured slope land and is prone to cause crumbling, and the surface cannot grow plants. While the rock-type slope land offers some improvements over the cemented slope land, growing of the plant is difficult to control.

### SUMMARY OF THE INVENTION

In view of the aforesaid disadvantages, the object of the invention is to provide a novel brick for slope lands that is made from virgin materials or wasted materials. The brick of the invention, whether it is made from the virgin materials or wasted materials, has a common feature of being formed in a porous structure. Thereby excessive water may be drained quickly on the slope land. Because the slope land built by the material of the invention can drain water effectively, crumbling can be prevented. The brick for slope lands of the invention further provides a space for growing plants. Thus forestry or planting condition on the slope land may be designed and cultivated to match the surrounding to improve the environment and protect the slope land. The porous structure of the brick for slope lands also can retain water to enable the soil under the brick to infiltrate water to nourish the plants growing in the planting space of the brick, therefore the plants may grow without additional human watering and management is easier. The porous brick that has good water permeability and retention properties also offers better sound absorption capability. Thus it can reduce noise level of the heavy traffic on the road bordering the slope lands.

The brick for slope lands according to the invention may be made in the form of a general rock or brick. It may be stacked and bonded by cement to form a slope land. In one aspect of the invention, the brick is formed in a structure for interconnection, such as having through holes or cavities that are coupled by reinforced bars or insert pins to engage with one another. In addition, the peripheral sides of the brick may also have a wedging structure to allow the brick to couple and stack and assemble without using external connection elements.

In short, the invention aims at providing an improved brick for slope lands to effectively overcome the shortcomings occurred to the conventional slope land construction.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a longitudinal cross section of FIG. 1.

FIGS. 3, 4 and 5 are schematic views of the embodiments of the invention in various stacking and coupling conditions.

FIG. 6 is a front view of an embodiment of the invention adopted for use on a sloped land.

### DESCRIPTION OF THE PREFERRED EMBODIMENTS

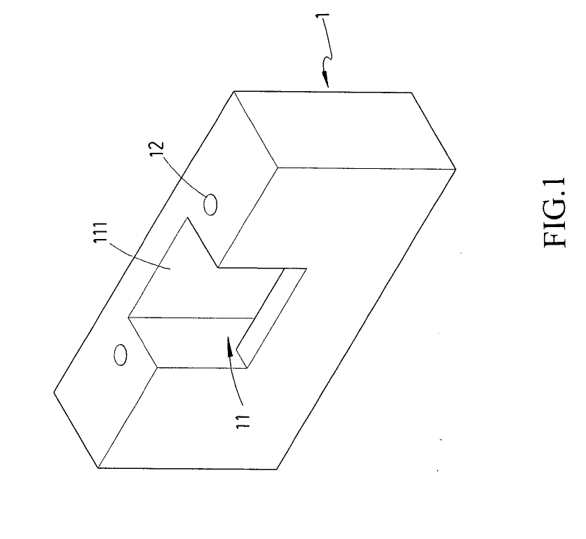

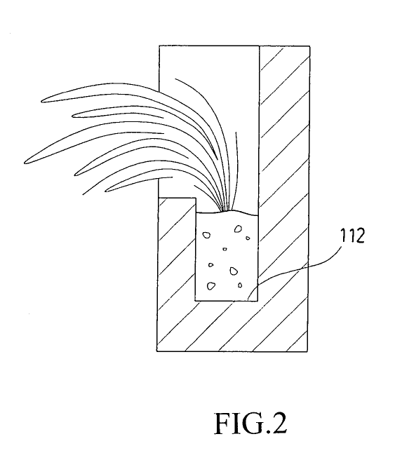

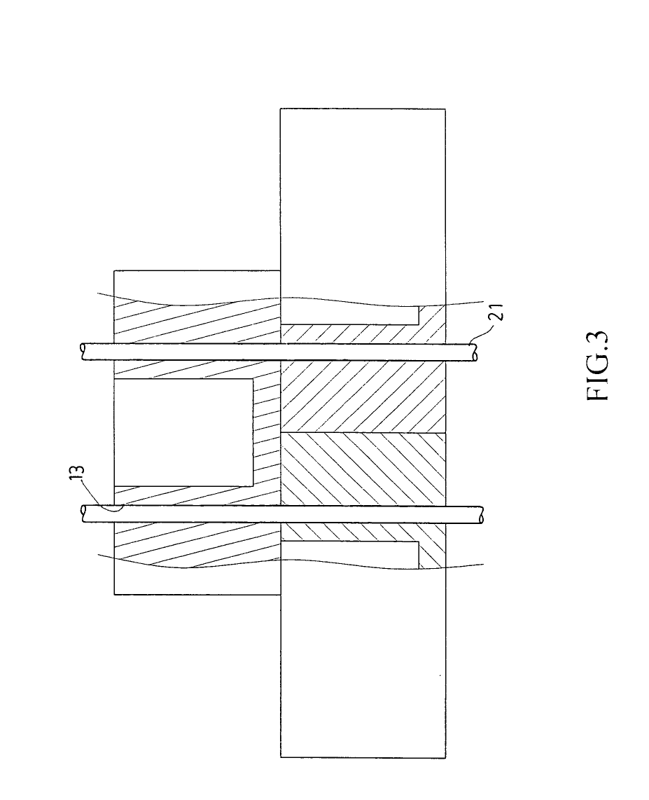

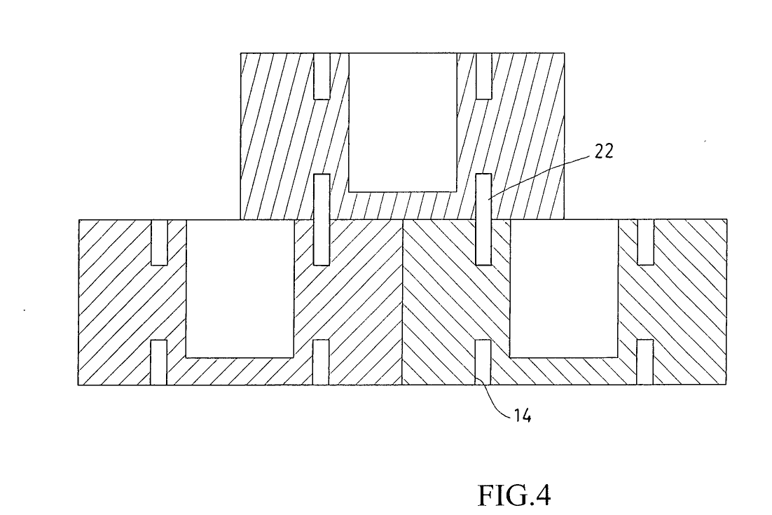

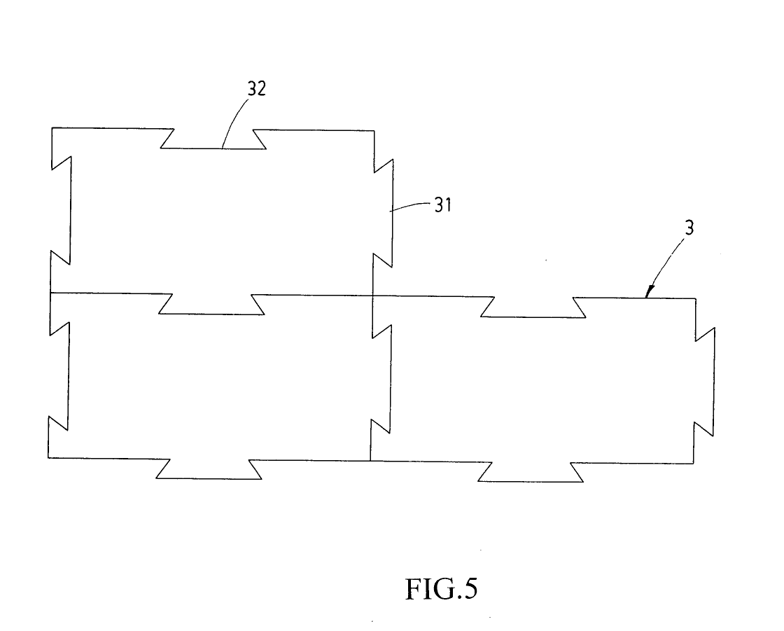

Refer to FIG. 1 for an embodiment of the invention. The brick 1 of the invention is made from virgin materials or waste materials and formed in a porous structure that has excellent water permeable and retaining properties. The porous bricks equipping with such properties are known in the art, details are omitted. The brick 1 has a space 11 for growing plants, preferably on an upper portion of one surface. The space has an opening 111 on the surface of one end of the brick 1 and a cavity 112 located deeply in the interior of the brick 1 (as shown in FIG. 2). There are two apertures 12 located at two sides of the space 11 that may be through holes running through the brick 1 or cavities of a selected depth. If the aperture is a through hole 13, an elongated reinforced bar 21 may run through the hole 13 to couple and assemble the bricks 1 (as shown in FIG. 3). If the aperture is a cavity 14, an insert pin 22 may be inserted to couple the brick 1 (as shown in FIG. 4). The cavity may be formed in longitudinal manner or transverse manner. Moreover, asides from coupling by external elements such as elongated reinforced bar 21 and pin 22, the brick may also be formed with a self-latching structure. FIG. 5 illustrates a brick 3, which has mail dovetail coupling troughs 31 and female dovetail coupling troughs 32 that may be wedged and coupled with one another to form a slope land.

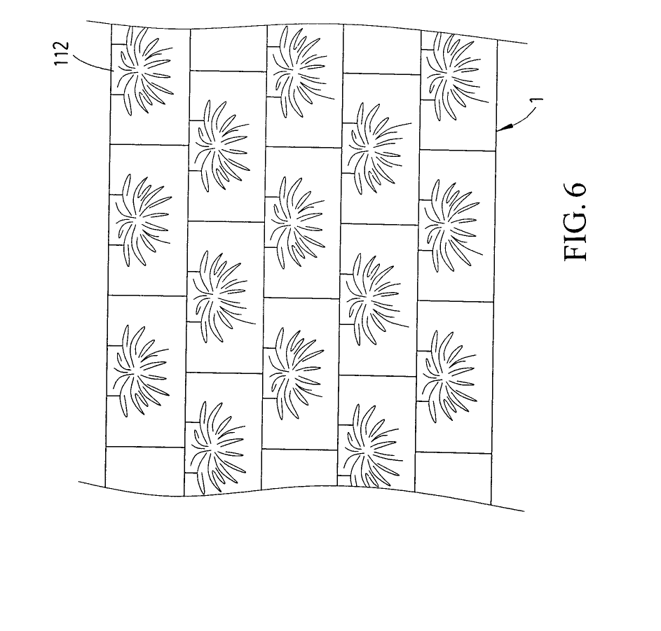

The cavity 112 in the space 11 can grow a desired plant 41, which is not limited to vines. The cavity 112 may contain soil 42 to grow the plant 41. The soil 42 is retained by a stopping wall 113 at the front end of the cavity 112 (as shown in FIG. 2). After the brick 1 is stacked layer by layer (as shown in FIG. 6), the cavity 112 is covered by the bottom of the brick 1 of an upper layer. Thus rainwater does not directly flow down into the cavity 112 from above and does flush away the soil 42. Therefore the invention can provide an excellent growing environment for plants.

1. An ecological brick for slope lands made from virgin materials or wasted materials and formed in a porous structure that has water permeable and retaining properties comprising a space on one side thereof for growing plants, a portion of the space located in the interior of the brick to form a cavity to hold the plants.

2. The ecological brick for slope lands of claim 1, wherein the brick has means to couple with one another.

3. The ecological brick for slope lands of claim 2, wherein the brick has a plurality of through holes to allow elongated reinforced bars to run through to couple the brick with one another.

4. The ecological brick for slope lands of claim 2, wherein the brick has a plurality of cavities to received insert pins to couple the brick with one another.
